(19) United States
(12) Patent Application Publication
(10) Pub. No.: US 2013/0212584 A1
(43) Pub. Date: Aug. 15, 2013

(54) METHOD FOR DISTRIBUTED CACHING AND SCHEDULING FOR SHARED NOTHING COMPUTER FRAMEWORKS

(71) Applicant: Juergen Heit, Sunnyvale, CA (US)

(72) Inventor: Juergen Heit, Sunnyvale, CA (US)

(73) Assignee: Robert Bosch GmbH, Stuttgart (DE)

(21) Appl. No.: 13/370,301

(22) Filed: Feb. 9, 2012

(51) Int. Cl. G06F 9/46

(52) U.S. Cl. 718/102

(57) ABSTRACT

In a distributed caching and scheduling method for a shared nothing computing framework, the framework includes an aggregator node and multiple computing nodes with local processor, storage unit and memory. The method includes separating a dataset into multiple data segments; distributing the data segments across the local storage units; and for each computing node, copying the data segment from the storage unit to the memory; processing the data segment to compute a partial result; and sending the partial result to the aggregator node. The method includes determining the data segment stored in local memory of computing nodes; and coordinating additional computing jobs based on the determination of the data segment stored in local memory. Coordinating can include scheduling new computing jobs using the data segment already stored in local memory, or to maximize the use of the data segments already stored in local memories.

### BACKGROUND OF THE INVENTION

This patent relates to architectures of distributed computing frameworks, and more particularly to enabling more efficient processing of parallel programs by means of distributed caching in shared nothing computing frameworks.

For a long time Moore's law had been endowed with a visionary capability, predicting computing speed would double every two years. In the past, indeed, technological progress in the fabrication of semi-conductors has enabled chip manufactures to reduce the size of integrated circuits and to increase clock speeds of processing units and memory busses. In this way, past technological progress of integrated circuits could adhere to Moore's law, and with every new product generation, computer chip manufacturers were able to provide products which allowed for faster processing speeds.

Today, the size of integrated circuits is approaching the molecular level, making further size reductions impossible. Different approaches for increasing computing power is needed. One approach is to leverage parallelism and integrate multiple processing cores onto a single chip. On these architectures, speedup is not achieved with higher clock frequencies, but by having multiple processing cores perform mostly independent tasks in parallel. However, programs need to be specially designed and implemented to exploit the properties of multi-core systems and take advantage of the additional computing power provided by multiple cores.

A drawback of the multi-core platforms is that the number of processing cores is static: no additional computing cores can be added to an integrated circuit. In order to accommodate the requirements of large scale data mining applications which deal with ever growing data sets, less tightly integrated systems are needed. One of the most scalable approaches for this is the approach of shared nothing computing frameworks. In shared nothing computing networks, the processing, memory and storage resources of individual computers are combined, and by connecting additional computers to the computing framework these resources can be extended.

In a shared nothing computing framework, several computers equipped with dedicated processing units, storage units, and memory modules, are connected by a computing framework. In this network, computers cannot directly access data which is physically located in memory modules or storage units of a different computer. Any exchange of data between two or more computers requires that these computers exchange messages over the network. In order for several computers in this network to run a program in parallel, software for coordinated processing is required. The coordination can be especially challenging when processing very large data sets with multi-pass algorithms.

Multi-pass algorithms describe computational processes in which input data has to be read multiple times for the calculation of a result. These types of algorithms play a special role in areas of science and technology that focus on discovering hidden patterns in very large amounts of data. On most computer systems, it takes about 10,000 times longer to access data from storage units than it takes to access data from memory. For this reason, it is important for multi-pass algorithms that all of the data required for a pass of the algorithm can be accessed directly from memory.

Without a data caching mechanism, multi-pass algorithms may need to re-read input data for every pass. The difference of data access speed for storage units compared to memory modules causes the multi-pass algorithm to be significantly slower. This is dependent on the number of passes the algorithm has to perform on the input data. This issue is illustrated by the following example: First consider a multi-pass algorithm that has linear computational complexity with respect to the size of the input. This means that given sufficient memory, as the amount of input data doubles, the algorithm should theoretically only take twice as long to process the input data and return a result. Assume furthermore, that the first given dataset can fit into the memory of the computer, but no additional space is left in the computer memory for additional data. Prior to the first pass of the algorithm over the input data, all of the data is copied from the storage unit to the memory module. After this initial data transfer to memory, all subsequent passes of the algorithm over the input data take 10 seconds each per 12 gigabytes of data. For this example, let us further assume that P=100 passes will have to be performed before a result can be returned. Consequently, the overall processing time will be 1000 seconds.

Now, consider the same algorithm applied to a new dataset which is very similar to the first dataset, but is twice as large as the first dataset. The new dataset cannot be copied into memory completely. Consequently, every single pass of the algorithm over the new input data needs to re-load the new dataset from the storage unit of the computer, which is typically about 10,000 times slower than accessing the data from memory. The increase in runtime for the algorithm can be estimated as follows: Let Ts be the time it takes to load the data from storage and Tp be the time it takes to process one pass of the algorithm over the data, and let P be the number of passes. If the whole data set fit into memory the overall processing time would be T_ideal=Ts+P*Tp, but since the data set is too large to be kept in memory, it needs to be reloaded from storage for every pass. This leads to an increased run-time of T_actual =P*Ts+P*Tp. For a data set of 24 Gigabytes, the time to load the data from storage to memory could be Ts=245.76 sec≈4 min 6 sec, assuming a data transfer rate of 100 Megabytes per second. If the whole data set fit into memory, the overall processing time would be T_ideal=245.76 sec+2* 100*10 sec≈37 min 26 sec. Since the data does not fit into memory the processing time is increased, however, to T_actual=100*245.76 sec+2000 sec≈7 hr 23 min. This means that processing will actually be almost 12 times slower than what it would be when all the data could be kept in memory.

In recent years, the amount of data available on the World Wide Web, in databases of online retailers and service providers, and in numerous other areas has increased dramatically. A large number of businesses that depend on these data sources, for example to identify customer preferences or patterns in user behavior, are processing more data in a single day in the year 2011 than they did during the entire year of 2003. Processing the increasing amounts of data requires computing platforms with more than 100 times the amount of memory as compared to less than a decade ago. Single and multi-core processing platforms have not kept pace with these requirements and cannot offer these amounts of memory on a single computer. Furthermore, the amount of memory that can be installed on these processing platforms is finite, but the increase in data availability is dynamic and does not appear to be slowing down in the near future. Shared nothing computing frameworks can be a suitable means for meeting these increasing demands.

Methods have been developed for running certain single-pass algorithms in shared nothing computing frameworks. However techniques for efficiently running multi-pass algorithms using shared nothing computing frameworks still need further development. It would be desirable to have a mechanism to increase the efficiency of the coordination software in a shared nothing computing framework to process very large data sets with multi-pass algorithms.

### SUMMARY OF THE INVENTION

A distributed caching and scheduling method for a shared nothing computing framework is disclosed, where the shared nothing computing framework includes an aggregator node and a plurality of computing nodes, each computing node including a local processor, a local storage unit and a local memory. The method includes separating a dataset for a current computing job into a plurality of data segments; distributing and storing the plurality of data segments across the local storage units of the plurality of computing nodes. For each of the plurality of computing nodes, the method includes copying the local data segment from the local storage unit to the local memory for processing; processing the local data segment using the local processor to compute a partial result; and sending the partial result to the aggregator node. The method also includes determining the local data segment stored in the local memory of at least one computing node of the plurality of computing nodes; and coordinating the scheduling of additional computing jobs on the shared nothing computing framework based on the determination of the data segment stored in the local memory of the at least one computing node.

The coordinating step can include scheduling a new computing job using the data segment already stored in the local memory of the at least one computing node for processing by the at least one computing nodes. The coordinating step can include scheduling a new computing job on the shared nothing computing framework to maximize the use of the data segments already stored in the local memories of the at least one computing node. The coordinating step can include tracking a time since last use for each of the local data segments; and removing a disused local data segment from local memory after the time since last use exceeds an expiration time limit.

The determining and coordinating steps of the distributed caching and scheduling method can include determining the local data segments stored in the local memories of a determined plurality of computing nodes of the plurality of computing nodes; and coordinating the scheduling of additional computing jobs on the shared nothing computing framework based on the determination of the local data segments stored in the local memories of the determined plurality of computing nodes. The coordinating step can include scheduling a new computing job using the data segments already stored in the local memories of the determined plurality of computing nodes for processing by the determined plurality of computing nodes, or scheduling a new computing job on the shared nothing computing framework to maximize the use of the data segments already stored in the local memories of the determined plurality of computing nodes.

The distributed caching method can also include receiving the partial results from the plurality of computing nodes at the aggregator node; computing a final result for a pass of the current computing job at the aggregator node; for each of the plurality of computing nodes, repeating the processing and sending steps; and scheduling additional passes of the current computing job to reduce copying data from the local storage unit to the local memory. The coordinating step can include scheduling an additional computing job using the data segments already stored in the local memories of the determined plurality of computing nodes for execution during the sending and receiving of the partial results and the computing a final result steps.

The coordinating step can include grouping jobs that operate on the same data segments to execute in direct succession. The coordinating step can also include not allowing more than an upper limit of jobs that operate on the same data segments to execute in direct succession while other jobs are waiting. The coordinating can also include tracking a job wait time or a time deadline for each job awaiting execution; and for a particular job, when the job wait time exceeds a maximum wait time or time exceeds the time deadline, scheduling the particular job to be the next job for execution.

A distributed caching and scheduling method is disclosed for a shared nothing computing framework that includes an aggregator node and a plurality of computing nodes, each computing node including a local processor, a local storage unit and a local memory. The method includes separating a dataset for a current computing job into a plurality of data segments; and distributing and storing the plurality of data segments across the local storage units of the plurality of computing nodes. For each of the plurality of computing nodes, the method includes organizing the data segment stored on the local storage unit into at least one local data sub-segments; copying one or more of the local data sub-segments from the local storage unit to the local memory for processing; processing the local data sub-segments in the local memory using the local processor to compute a partial result; and sending the partial result to the aggregator node. The method also includes determining the local data sub-segments stored in the local memories of a determined plurality of computing nodes of the plurality of computing nodes; and coordinating the scheduling of additional computing jobs on the shared nothing computing framework based on the determination of the local data sub-segments stored in the local memories of the determined plurality of computing nodes.

The coordinating step can include scheduling a new computing job using the local data sub-segments already stored in the local memories of the determined plurality of computing nodes for processing by the determined plurality of computing nodes; or scheduling a new computing job on the shared nothing computing framework to maximize the use of the local data sub-segments already stored in the local memories of the determined plurality of computing nodes.

The distributed caching and scheduling method can also include receiving the partial results from the plurality of computing nodes at the aggregator node; computing a final result for a pass of the current computing job at the aggregator node; for each of the plurality of computing nodes, repeating the processing and sending steps; and scheduling additional passes of the current computing job to reduce the copying of local data sub-segments from the local storage unit to the local memory. The coordinating step can also include scheduling an additional computing job using the local data sub-segments already stored in the local memories of the determined plurality of computing nodes for execution during the sending and receiving of the partial results and the computing a final result steps.

The coordinating step can include grouping jobs that operate on the same local data sub-segments to execute in direct succession. The coordinating step can also include not allowing more than an upper limit of jobs that operate on the same local data sub-segments to execute in direct succession while other jobs are waiting. The coordinating step can include tracking a job wait time or a time deadline for each job awaiting execution; and for a particular job, when the job wait time exceeds a maximum wait time or time exceeds the time deadline, scheduling the particular job to be the next job for execution.

### BRIEF DESCRIPTION OF THE DRAWINGS

The above mentioned and other features and objects of this invention, and the manner of attaining them, will become more apparent and the invention itself will be better understood by reference to the following description of exemplary embodiments of the invention taken in conjunction with the accompanying drawings, wherein:

FIG. 1 illustrates a shared nothing computing framework without a distributed caching mechanism; and

FIG. 2 illustrates a schematic of an exemplary embodiment of a distributed caching and scheduling mechanism for a shared nothing computing network.

Corresponding reference characters indicate corresponding parts throughout the several views. Although the exemplification set out herein illustrates embodiments of the invention, in several forms, the embodiments disclosed below are not intended to be exhaustive or to be construed as limiting the scope of the invention to the precise forms disclosed.

### DESCRIPTION OF EXEMPLARY EMBODIMENTS

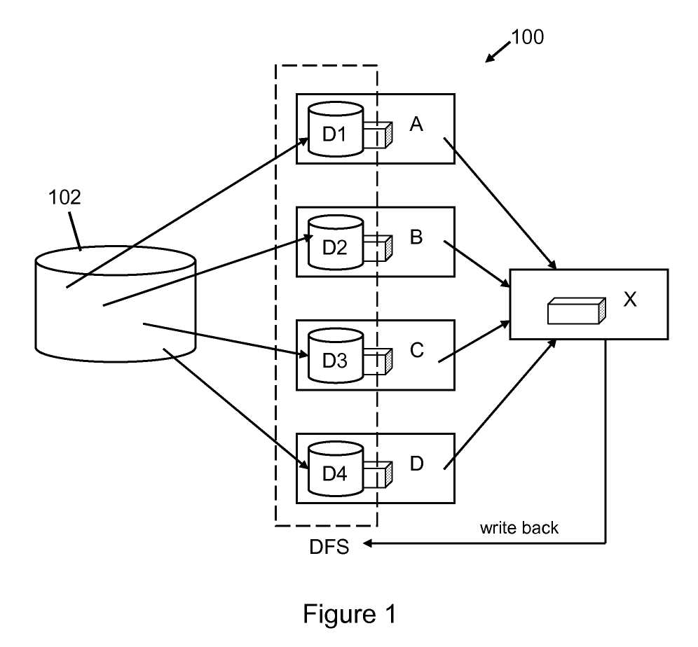

FIG. 1 depicts a shared nothing computing framework 100 without a distributed caching mechanism. The shared nothing computing framework 100 includes an original or replicated very large dataset 102; four processing computer nodes A, B, C, D; and an aggregation computer node X. The system 100 also includes a distributed file system (DFS) which stores segments of the very large dataset 102 on storage units located on the individual processing nodes A, B, C, D in the network 100. The dataset 102 may be larger than any single storage unit of a particular processing node A, B, C, D. When processing the data, each processing node A, B, C, D processes only the data segment located in its dedicated storage unit. After processing of a data segment completes on an individual node, the completed processing node A, B, C, or D sends its partial result to the aggregation computer node X which combines all of the partial results into a final result.

Multiple different datasets can be stored in the distributed file system, and coordination software enables users of the system 100 to select the dataset to be processed with an algorithm of their choice. The selection of a dataset and processing algorithm by a user of the system is called “defining a job.” To execute a job, the coordination software can automatically start the computation processes on each of the applicable processing nodes A, B, C, D, and can facilitate reception and aggregation of partial results on the aggregator node X. The data segments on each of the processing nodes A, B, C, D can be removed from local memory as the computation finishes so that users can specify and execute new jobs.

For some multi-pass algorithms, the aggregator computing node X may need to compute a result for a whole pass over the input data 102, before a subsequent pass can be executed. In each pass of the multi-pass algorithm, the same algorithm may be executed. The results from one pass of the algorithm may be used as input for the subsequent pass of the algorithm. Users typically define a sequence of jobs for the coordinating software in order to process multi-pass algorithms in shared nothing computing frameworks.

In order to process these jobs efficiently, it may be desirable not to remove the data segments on the processing nodes A, B, C, D from memory immediately after completion of an individual pass but instead to cache the data segments intelligently, so that the data segments that are needed by subsequent jobs can be kept in the memory of the appropriate processing nodes A, B, C, or D. In this way, the delay of reading data segments repeatedly from storage can be avoided.

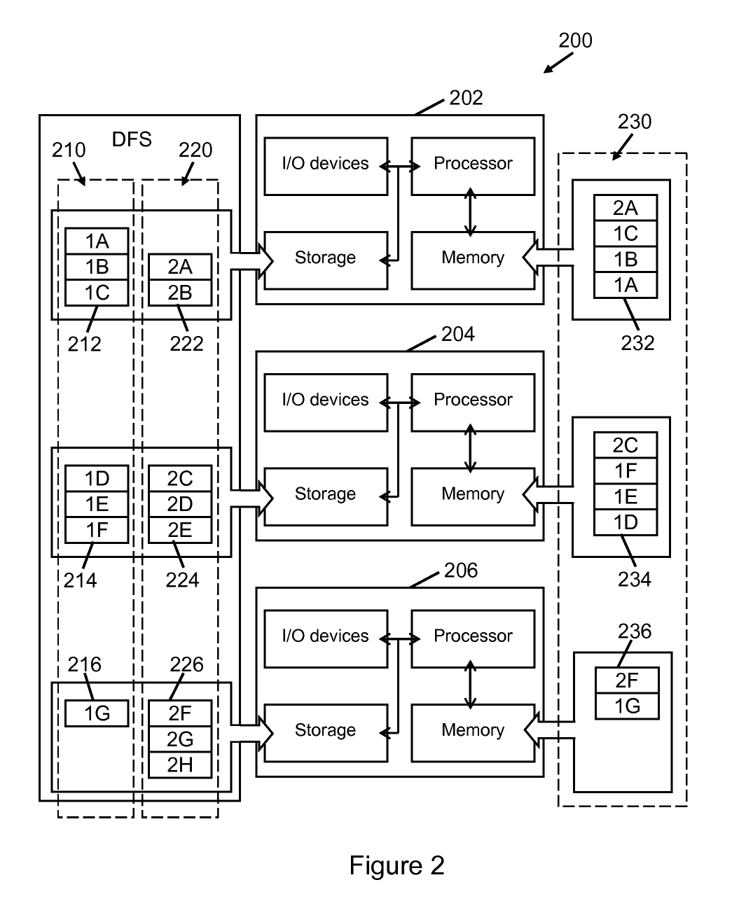

FIG. 2 shows a schematic of an exemplary embodiment of a distributed caching and scheduling mechanism for a shared nothing computing network 200. The shared nothing computing network 200 includes three processing computer nodes 202, 204, 206. Each of the processing nodes 202, 204, 206 includes a local processing unit coupled to a local memory, a local storage unit and local input/output (I/O) devices. The distributed file system includes segments of two large datasets, a first dataset 210 and a second dataset 220, that are distributed across the local storage units of the three processing computer nodes 202, 204, 206. The data segment stored in each of the local storage units can be subdivided into sub-segments.

In the exemplary embodiment of FIG. 2, both datasets 210 and 220 include three data segments. The first dataset 210 includes a first data segment 212, comprising data sub-segments 1A, 1B, 1C, that is stored in the storage unit of the first processing computer node 202; and a second data segment 214, comprising data sub-segments 1D, 1E, 1F, that is stored in the storage unit of the second processing computer node 204; and a third data segment 216, comprising data sub-segment 1G, that is stored in the storage unit of the third processing computer node 206. The second dataset 220 includes a first data segment 222, comprising data sub-segments 2A, 2B, that is stored in the storage unit of the first processing computer node 202; and a second data segment 224, comprising data sub-segments 2C, 2D, 2E, that is stored in the storage unit of the second processing computer node 204; and a third data segment 226, comprising data sub-segments 2F, 2G, 2H, that is stored in the storage unit of the third processing computer node 206.

When a job is executed in the system 200, the data segments of the applicable dataset are fetched from the local storage unit and copied to the local memory on each of the processing nodes 202, 204, 206. The computing nodes 202, 204, 206 can process their local input data in parallel by applying the algorithm to the data segments in their local memory. After one of the computing nodes 202, 204, 206 completes a pass of the algorithm, it can send its partial result to an aggregator node (not shown in FIG. 2) which can construct an end result for the pass from the applicable partial results before another pass is started.

The coordinating software in a shared nothing computing framework is typically unaware of the data requirements for subsequent jobs, and does not cache previously read data in memory. FIG. 2, however, shows an exemplary method for distributed caching that can take advantage of this information. The right side of FIG. 2 illustrates a distributed cache 230 distributed across the local memory of the processing nodes 202, 204, 206. The distributed cache 230 includes a first cache segment 232 stored in the local memory of the first processing node 202, a second cache segment 234 stored in the local memory of the second processing node 204, and a third cache segment 236 stored in the local memory of the third processing node 206.

FIG. 2 shows the state of the distributed cache 230 after all jobs operating on dataset 1 have been finished, and right after the first job for dataset 2 has been started. The first cache segment 232 in the local memory of the first processing node 202 continues to hold data sub-segments 1A, 1B, 1C of dataset 1 and has loaded data sub-segment 2A of dataset 2. The second cache segment 234 in the local memory of the second processing node 204 continues to hold data sub-segments 1D, 1E, 1F of dataset 1 and has loaded data sub-segment 2C of dataset 2. The third cache segment 236 in the local memory of the third processing node 206 continues to hold data sub-segment 1G of dataset 1 and has loaded data sub-segment 2F of dataset 2.

Previously read data sub-segments can be maintained in the cache segment 232, 234, 236 on the individual computing nodes 202, 204, 206 until they have to be exchanged for sub-segments of a different dataset because a new job requires the sub-segments of the different dataset and there is not enough space in local memory to maintain all of the former data sub-segments. One exemplary embodiment for this mechanism is a most-recently-used caching policy which replaces the cache sub-segments in a local memory that have not been accessed for the longest time with data sub-segments on the storage unit which currently are not in the local memory but which are needed by the new job.

In practice, many different jobs, possibly originating from different users may have to be executed by the coordinating software of shared nothing computing frameworks. To maximize throughput in these networks, jobs and job sequences can be scheduled such that the contents of the distributed cache 230 is exchanged as little as possible. An exemplary embodiment of the scheduling and caching mechanism can group jobs and job sequences that operate on the same input data together, such that all jobs on the same input data are executed in direct succession. In a heavily used shared nothing computing framework with this exemplary scheduling and caching mechanism, jobs or job sequences that operate on a rarely used input data set may never be executed, if a great number of jobs are scheduled for execution that all operate on the same, more frequently used dataset. Exemplary scheduling and caching methods to overcome this can define upper limits on the number of subsequent jobs that can be executed in sequence that operate on the same dataset while other jobs are waiting, or to define upper time limits for a job before it becomes the next job in the queue or define a time deadline for execution of a job.

The scheduling and caching embodiments can also perform round robin scheduling between jobs or job sequences that have been defined by different users. Round-robin scheduling describes a method of choosing a resource for a task from a list of available resources where the scheduler selects a resource pointed to by a counter from a list after which the counter is incremented, and when the end of the list of resources is reached, the counter returns to the beginning of the list. Round-robin selection can prevent starvation of resources, as every resource will eventually be chosen by the scheduler. A weighted round-robin method can be used which associates weights with users indicating the priority of a job originating from a certain user, and a job from a user with higher weight can takes priority over a job from a user with lower weight. The weighted round-robin can also take into account the elapsed waiting time or a time deadline for a job and increase the weight based on the elapsed wait time.

After a computing node has finished processing a single pass on its part of the input data, the partial result from that computing node is communicated to the aggregator node, and the aggregator node can compute an end-result from the partial results of the applicable processing nodes. Both the process of communicating the partial results from the individual processing nodes to the aggregator node and the process of assembling the partial results into the end-result on the aggregator node take time. During this time, different jobs or job sequences that require the same dataset as input can be executed on the computing nodes. For example, a caching aware job scheduling mechanism, can schedule different job sequences such that given two job sequences which require the same or similar datasets as input, can schedule and execute a particular job of a second job sequence B on the computing nodes while the aggregator node assembles partial results from a previously executed job of a first job sequence A.

In a shared nothing computing network, different coordination software programs may run concurrently or cooperatively. If the scheduling and caching mechanisms described above were to keep data sub-segments in memory indefinitely, resources on the individual computing nodes could be too scarce to enable execution of jobs or job sequences scheduled by the different coordination software programs. For this reason, an embodiment of the caching and scheduling mechanism can remove all or some of the data sub-segments stored in the distributed cache after a certain amount of time has expired during which those data sub-segments have not been accessed.

When running a multi-pass algorithm that would encounter significant delay from reloading memory from storage units, the distributed caching method can prompt the users or system administrators to add more computing nodes to the shared nothing computing framework before the job is started.

While this invention has been described as having an exemplary design, the present invention may be further modified within the spirit and scope of this disclosure. This application is therefore intended to cover any variations, uses, or adaptations of the invention using its general principles.

We claim:

1. A distributed caching and scheduling method for a shared nothing computing framework including an aggregator node and a plurality of computing nodes, each computing node including a local processor, a local storage unit and a local memory, the method comprising:
separating a dataset for a current computing job into a plurality of data segments;
distributing and storing the plurality of data segments across the local storage units of the plurality of computing nodes;
for each of the plurality of computing nodes,
copying the local data segment from the local storage unit to the local memory for processing;
processing the local data segment using the local processor to compute a partial result; and
sending the partial result to the aggregator node;
determining the local data segment stored in the local memory of at least one computing node of the plurality of computing nodes; and
coordinating the scheduling of additional computing jobs on the shared nothing computing framework based on the determination of the data segment stored in the local memory of the at least one computing node.

2. The distributed caching and scheduling method of claim 1, wherein the coordinating step comprises:
scheduling a new computing job using the data segment already stored in the local memory of the at least one computing node for processing by the at least one computing node.

3. The distributed caching and scheduling method of claim 1, wherein the coordinating step comprises:
scheduling a new computing job on the shared nothing computing framework to maximize the use of the data segments already stored in the local memories of the at least one computing node.

4. The distributed caching and scheduling method of claim 1, wherein the determining and coordinating steps comprise:
determining the local data segments stored in the local memories of a determined plurality of computing nodes of the plurality of computing nodes; and
coordinating the scheduling of additional computing jobs on the shared nothing computing framework based on the determination of the local data segments stored in the local memories of the determined plurality of computing nodes.

5. The distributed caching and scheduling method of claim 4, wherein the coordinating step further comprises:
scheduling a new computing job using the data segments already stored in the local memories of the determined plurality of computing nodes for processing by the determined plurality of computing nodes.

6. The distributed caching and scheduling method of claim 4, wherein the coordinating step comprises:
scheduling a new computing job on the shared nothing computing framework to maximize the use of the data segments already stored in the local memories of the determined plurality of computing nodes.

7. The distributed caching and scheduling method of claim 4, further comprising:
receiving the partial results from the plurality of computing nodes at the aggregator node;
computing a final result for a pass of the current computing job at the aggregator node;
for each of the plurality of computing nodes, repeating the processing and sending steps; and
scheduling additional passes of the current computing job to reduce copying of data from the local storage unit to the local memory.

8. The distributed caching and scheduling method of claim 7, wherein the coordinating step further comprises:
scheduling an additional computing job using the data segments already stored in the local memories of the determined plurality of computing nodes for execution during the sending and the receiving of the partial results and the computing a final result steps.

9. The distributed caching and scheduling method of claim 4, wherein the coordinating step comprises:
grouping jobs that operate on the same data segments to execute in direct succession.

10. The distributed caching and scheduling method of claim 9, wherein the coordinating step further comprises:
not allowing more than an upper limit of jobs that operate on the same data segments to execute in direct succession while other jobs are waiting.

11. The distributed caching and scheduling method of claim 9, wherein the coordinating step further comprises:
tracking a job wait time or a time deadline for each job awaiting execution;
for a particular job, when the job wait time exceeds a maximum wait time or time exceeds the time deadline, scheduling the particular job to be the next job for execution.

12. The distributed caching and scheduling method of claim 4, wherein the coordinating step comprises:
tracking a time since last use for each of the local data segments; and
removing a disused local data segment from local memory after the time since last use exceeds an expiration time limit.

13. A distributed caching and scheduling method for a shared nothing computing framework including an aggregator node and a plurality of computing nodes, each computing node including a local processor, a local storage unit and a local memory, the method comprising:
separating a dataset for a current computing job into a plurality of data segments;
distributing and storing the plurality of data segments across the local storage units of the plurality of computing nodes;
for each of the plurality of computing nodes,
organizing the data segment stored on the local storage unit into at least one local data sub-segments;
copying one or more of the local data sub-segments from the local storage unit to the local memory for processing;
processing the local data sub-segments in the local memory using the local processor to compute a partial result; and
sending the partial result to the aggregator node;
determining the local data sub-segments stored in the local memories of a determined plurality of computing nodes of the plurality of computing nodes; and
coordinating the scheduling of additional computing jobs on the shared nothing computing framework based on the determination of the local data sub-segments stored in the local memories of the determined plurality of computing nodes.

14. The distributed caching and scheduling method of claim 13, wherein the coordinating step further comprises:
scheduling a new computing job using the local data sub-segments already stored in the local memories of the determined plurality of computing nodes for processing by the determined plurality of computing nodes.

15. The distributed caching and scheduling method of claim 13, wherein the coordinating step comprises:
scheduling a new computing job on the shared nothing computing framework to maximize the use of the local data sub-segments already stored in the local memories of the determined plurality of computing nodes.

16. The distributed caching and scheduling method of claim 13, further comprising:
receiving the partial results from the plurality of computing nodes at the aggregator node;
computing a final result for a pass of the current computing job at the aggregator node;.
for each of the plurality of computing nodes, repeating the processing and sending steps; and
scheduling additional passes of the current computing job to reduce the copying of local data sub-segments from the local storage unit to the local memory.

17. The distributed caching and scheduling method of claim 16, wherein the coordinating step further comprises:
scheduling an additional computing job using the local data sub-segments already stored in the local memories of the determined plurality of computing nodes for execution during the sending and receiving of the partial results and the computing a final result steps.

18. The distributed caching and scheduling method of claim 13, wherein the coordinating step comprises:
grouping jobs that operate on the same local data sub-segments to execute in direct succession.

19. The distributed caching and scheduling method of claim 18, wherein the coordinating step further comprises:
not allowing more than an upper limit of jobs that operate on the same local data sub-segments to execute in direct succession while other jobs are waiting.

20. The distributed caching and scheduling method of claim 9, wherein the coordinating step further comprises:
tracking a job wait time or a time deadline for each job awaiting execution;
for a particular job, when the job wait time exceeds a maximum wait time or time exceeds the time deadline, scheduling the particular job to be the next job for execution.
